(19) United States
(12) Patent Application Publication
(10) Pub. No.: US 2012/0227559 A1
(43) Pub. Date: Sep. 13, 2012

(54) ANVIL FOR FIBER ROVING CHOPPER

(75) Inventor: James H. Rohrer, Randolph, NJ (US)

(73) Assignee: GRACO MINNESOTA INC., Minneapolis, MN (US)

(21) Appl. No.: 13/501,214

(22) PCT Filed: Nov. 23, 2010
(86) PCT No.: PCT/US10/03030

§ 371 Date: Apr. 10, 2012

Related U.S. Application Data
(60) Provisional application No. 61/263,469, filed on Nov. 23, 2009.

(51) Int. Cl. D01G 1/04; B26D 1/22

(52) U.S. Cl. 83/347; 83/659

(57) ABSTRACT

An anvil assembly for a fiber roving chopper comprises an annular roller and an annular anvil wheel. The annular roller comprises an inner diameter surface with a plurality of dovetails, and an outer diameter surface comprising a deformable material. The annular anvil wheel comprises an inner diameter surface forming a central bore for mounting the anvil assembly in the fiber roving chopper, and an outer diameter surface extending between a first end and a second end and having a plurality of dovetail slots that receive the plurality of dovetails.

### CROSS-REFERENCE TO RELATED APPLICATION(S)

This application claims priority under 35 U.S.C. §120 to U.S. provisional application Ser. No. 61/263,469, entitled “ANVIL CHOPPER,” filed Nov. 23, 2009 by inventor James Rohrer, the contents of which are incorporated by this reference.

This application claims priority under 35 U.S.C. §119 to PCT application Serial No. PCT/2010/______, entitled “ANVIL FOR FIBER ROVING CHOPPER,” filed Nov. 23, 2010 by inventor James Rohrer, the contents of which are incorporated by this reference.

The present application is related to the following co-pending application filed on the same day as this application, entitled “CUTTER BLADE HEAD FOR FIBER ROVING CHOPPER” by inventors James Rohrer and Jonathan McMichael and having U.S. patent application Ser. No. ______/Attorney Docket Number G372.12-019, the contents of which are incorporated by this reference.

### BACKGROUND

The present invention relates generally to a chopper device that distributes fiber material into a stream of resin material dispensed from a spray gun. In particular, the present invention relates to an anvil assembly used in the chopper device.

Chopper guns are frequently used in the composite material industry to form large, shaped products, such as in the marine and watercraft industries and pool and spa industries. Chopper guns comprise assemblies of a fiber chopper and a liquid spray gun. Compressed air is typically supplied to the chopper gun to power a pumping mechanism in the spray gun and an air motor in the fiber chopper. The spray gun typically receives a liquid resin material and a liquid catalyst material. Actuation of a trigger on the gun dispenses the materials into a mix chamber before being sprayed out of a nozzle of the gun. Mixing of the catalyst with the resin begins a solidification process, which eventually leads to a hard, rigid material being formed upon complete curing of the materials. The fiber chopper is typically mounted on top of the spray gun. The fiber chopper receives rovings of a fiber material, such as fiberglass, which passes between an idler wheel, an anvil and a cutter blade head. The fiber rovings are cut into small segments between the anvil and cutter blade head while being propelled out of the chopper by rotation of the anvil and the cutter blade head by the air motor. The segments of fiber are mixed into the sprayed mixture of resin and catalyst such that the final cured product is fiber reinforced.

The blade head and anvil of the fiber chopper include consumable pieces that must be replaced after a threshold wear level is surpassed. For example, the blade head typically includes a plurality of razor blades inserted into slots on a blade wheel. Also, the anvil includes a roller of soft material into which blades of the cutter blade head penetrate while slicing or chopping the fiber roving. Thus, it is necessary to frequently disassemble the fiber chopper to access the cutter blade head and anvil, after which further disassembly of those components is also needed. In particular, it is necessary to remove the anvil roller from an anvil wheel and each blade of the cutter blade head. In prior art anvils, the deformable roller was press fit over the anvil wheel. In these anvil assemblies, it is difficult to remove the worn anvil roller from the anvil wheel and to attach a new anvil roller. There is, therefore, a need for a simpler system and method for retaining anvil rollers on anvil wheels in an anvil assembly for a fiber roving chopper.

### SUMMARY

The present invention is directed to an anvil assembly for a fiber roving chopper. The anvil assembly comprises an annular roller and an annular anvil wheel. The annular roller comprises an inner diameter surface with a plurality of dovetails, and an outer diameter surface comprising a deformable material. The annular anvil wheel comprises an inner diameter surface forming a central bore for mounting the anvil assembly in the fiber roving chopper, and an outer diameter surface extending between a first end and a second end and having a plurality of dovetail slots that receive the plurality of dovetails.

### BRIEF DESCRIPTION OF THE DRAWINGS

FIG. 1 is an exploded view of a liquid spray gun and a fiber roving chopper assembly in which an anvil assembly of the present invention is used.

FIG. 2A is a perspective view of the fiber roving chopper of FIG. 1 showing a cutter blade head.

FIG. 2B is a rear end view of the fiber roving chopper of FIG. 1 showing fiber roving inlet holes.

FIG. 2C is a perspective view of the fiber roving chopper of FIG. 1 with a cover removed to show a cutter blade head, an anvil assembly and an idler wheel.

FIG. 3 is an exploded view of the anvil assembly of FIG. 2C showing a retention cap, a roller body and an anvil wheel.

FIG. 4 is an exploded view of the retention cap of FIG. 3 showing retention tabs and a biasing spring.

FIG. 5 is a perspective view of the anvil wheel of FIG. 3 showing a cap retention flange for engaging the retention tabs of FIG. 4.

### DETAILED DESCRIPTION

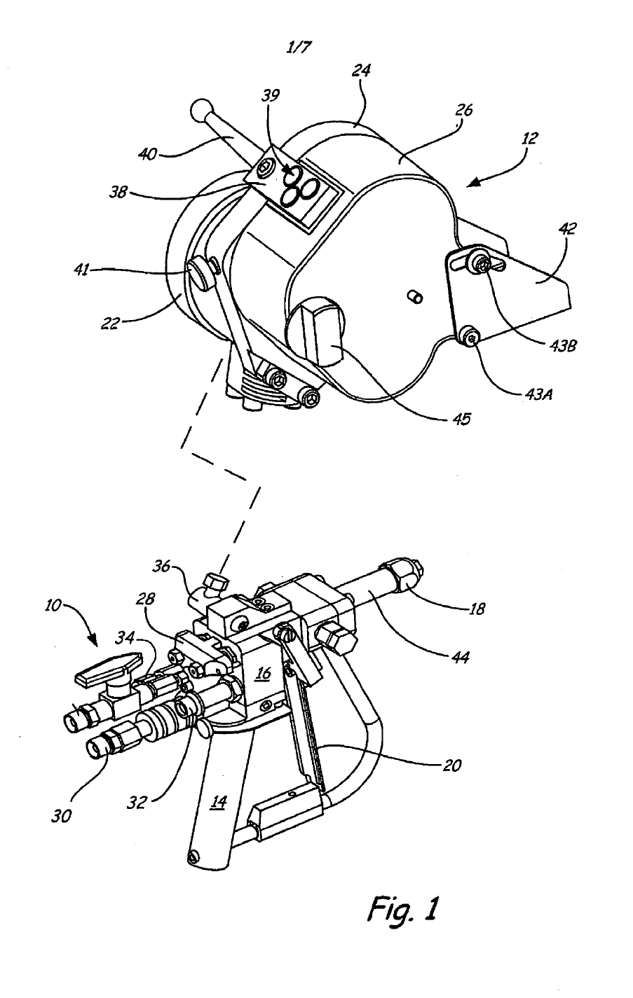

FIG. 1 is an exploded view of an assembly of liquid spray gun 10 and fiber roving chopper 12 in which a cutter blade head of the present invention is used. In FIG. 1, fiber roving chopper 12 is shown slightly enlarged with respect to liquid spray gun 10. Liquid spray gun 10 comprises a two component internal mixing gun having handle 14, valve body 16, nozzle 18 and trigger 20. Fiber roving chopper 12 includes air motor 22, housing 24 and cover 26. Valve body 16 of spray gun 10 includes valve assembly 28, air inlet 30, material inlet 32, catalyst inlet 34 and air outlet 36. Housing 24 of fiber roving chopper 12 includes fiber inlet 38, openings 39, lever 40, knob 41, fasteners 43A and 43B, knob 45 and cover 26 includes dispenser chute 42.

In the embodiment shown, spray gun 10 comprises a two component mixing gun that receives two liquid components that mix when dispensed to produce a mixture that cures into a hardened material. A first component comprises a resin material, such as a polyester resin or a vinyl ester, and is fed into valve body 16 at material inlet 32. A second component comprises a catalyst material that causes the resin material to harden, such as Methyl Ethyl Ketone Peroxide (MEKP), and is fed into valve body 16 at catalyst inlet 34. Material inlet 32 and catalyst inlet 34 feed materials, respectively, into valves seated within valve body 16 and connected to valve assembly 28. Other inlets are provided to gun 10 for other fluids such as a solvent. Actuation of trigger 20 simultaneously causes valves of valve assembly 28 to open and causes pressurized components to flow into nozzle 18. As shown, spray gun 10 comprises an internal mixer where the two components are pressurized at inlets 32 and 34 by an external source (not shown) and mixed within tube 44 before entering nozzle 18. Pressurized air may also be provided to nozzle 18 to shape or direct the mixed flow stream. In other embodiments, the materials are mixed outside of gun 10 after being pressurized within valve body 16 with air from inlet 30 and atomized by a mixing nozzle.

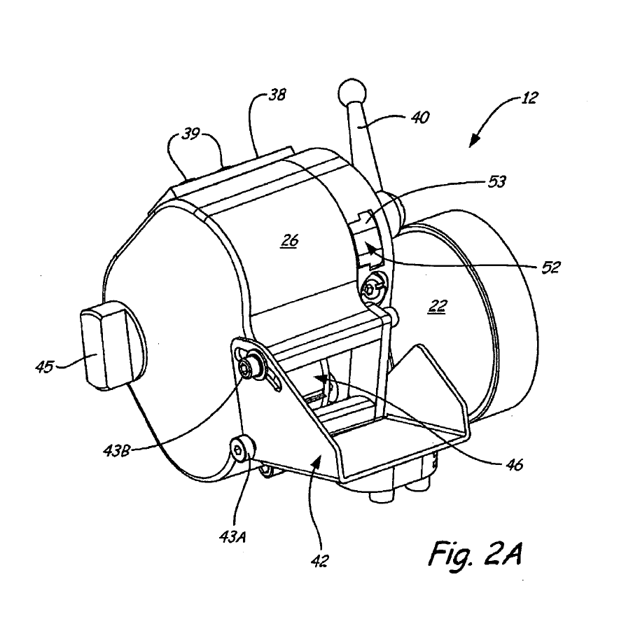

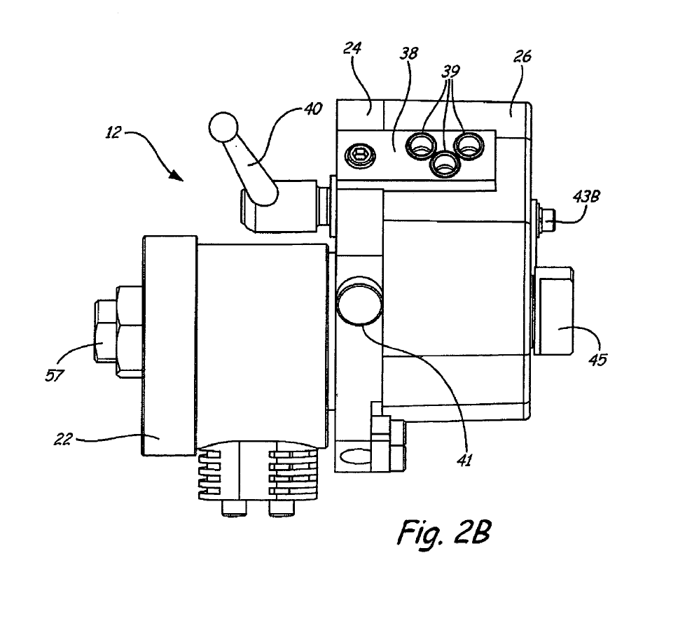

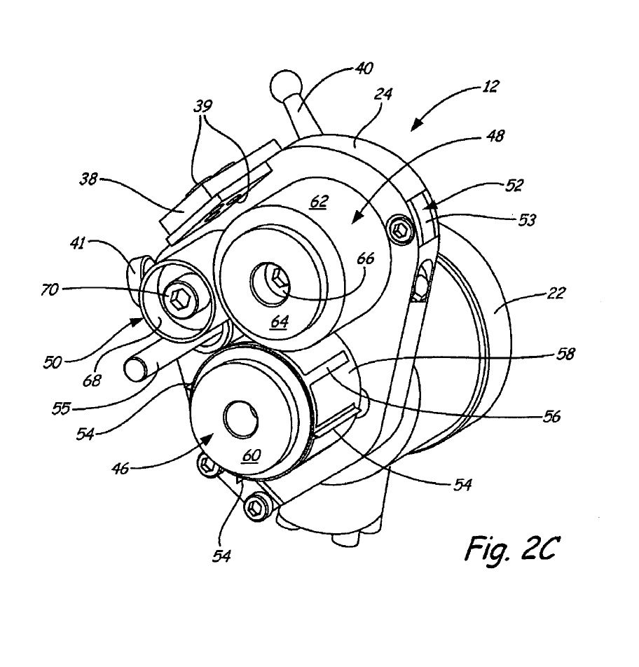

Pressurized air from air inlet 30 is also fed through valve body 16 to outlet 36, which connects to an inlet (not shown) on air motor 22 of fiber chopper 12. Rovings or strands of a fiber material, such as fiberglass, are fed into cover 26 through openings in fiber inlet 38. Activation of air motor 22 by actuation of trigger 20 causes the rovings to be pulled into a cutter blade head by an anvil and idler wheel mounted on housing 24, as will be discussed in greater detail with respect to FIG. 2. Positions of the anvil and idler wheel are adjusted with respect to the cutter blade head using lever 40 and knob 41. The chopped roving pieces are expelled from dispenser 42 into the mixed stream of resin and catalyst materials from nozzle 18 such that the hardened material includes fiber reinforcements that increase strength of the final product.

It is frequently necessary to remove cover 26 from housing 24 of chopper 12 to perform routine maintenance after spray gun 10 and fiber chopper 12 are operated. Specifically, blades of the cutter blade head and a cutting surface of the anvil must be replaced, as the blades become dull from cutting the rovings and the cutting surface becomes lacerated from the blades. The anvil assembly of the present invention is quickly and easily removed from chopper 12 once cover 26 is removed. Furthermore, a roller body can be easily and safely replaced in the anvil assembly of the present invention.

FIG. 2A is a perspective view of fiber roving chopper 12 of FIG. 1 showing cutter blade head 46. FIG. 2B is a top view of fiber roving chopper 12 of FIG. 1 showing fiber roving inlet holes 39. FIG. 2C is a perspective view of fiber roving chopper 12 of FIG. 1 with cover 26 removed to show cutter blade head 46, anvil assembly 48 and idler wheel 50. FIGS. 2A-2C are discussed concurrently, with specific emphasis on FIG. 2C. Fiber chopper 12 also includes air motor 22, housing 24, fiber inlet 38, openings 39, lever 40, knob 41, dispenser chute 42, fasteners 43A and 43B, knob 45, slide bar assembly 52 and tube 55. Blade head 46 includes blades 54, blade cartridge 56, spacer spool 58 and retention cap 60. Anvil assembly 48 includes roller body 62, anvil wheel 63, retention cap 64 and fastener 66. Idler wheel 50 includes roller 68 and fastener 70.

Cover 26 comprises a multi-sided body having an opening that mates with housing 24 to conceal cutter blade head 46, anvil 48 and idler wheel 50. Cover 26 includes an opening to allow chopped rovings from cutter blade head 46 to be thrown from chopper 12. Dispenser chute 42 mounts to cover 26 with fasteners 43A and 43B near the opening to receive chopped rovings from cutter blade head 46. Dispenser chute 42 comprises a three-sided angled plate along which chopped rovings pass after being cut by chopper head assembly 46. The angle of dispenser chute 42 on fasteners 43A can be adjusted using fasteners 43B to change the trajectory of the chopped roving pieces. Knob 45 extends into cover 26 to engage tube 55 (FIG. 2C) and retain cover 26 in engagement with housing 24.

With reference to FIG. 2C, cutter blade head 46, anvil assembly 48 and idler wheel 50 are mounted for rotation on housing 24. Specifically, cutter blade head 46 is mounted directly onto a drive shaft extending from shaft support 57 (FIG. 2B) of air motor 22, through housing 24, and into retention cap 60. Anvil assembly 48 and idler wheel 50 are mounted to shafts cantilevered from slide bar assembly 52 in housing 24. Fasteners 66 and 70 are typically in threaded engagement with the shafts to retain anvil 48 and idler wheel 50, respectively. Slide bar assembly 52 comprises a rectangular bar that extends into a corresponding slot in housing 24 between knob 41 and end stop 53. A spring biases the slide bar away from end stop 53, which is secured to housing 24, to push anvil assembly 48 into contact with cutter blade head 46. Lever 40 is used to adjust the position of the slide bar, including anvil assembly 48 and idler wheel 50, with respect to cutter blade head 46 by overcoming the spring bias. The position of idler wheel 50 with respect to anvil assembly 48 on the slide bar of slide bar assembly 52 is adjusted using knob 41. Adjustment of knob 41 allows for rovings of different thicknesses to be fed between anvil assembly 48 and idler wheel 50. Adjustment of lever 40 controls engagement of cutter blade head 46 with anvil assembly 48, thereby controlling feeding of rovings into fiber inlet 38.

Air motor 22 rotates cutter blade head 46 by rotation of a drive shaft that extends substantially coaxially with shaft support 57 of air motor 22. Engagement of blades 54 with roller 62 causes anvil assembly 48 to rotate as well. Anvil assembly 48 drives rotation of idler wheel 50 through engagement with roller 68. Rovings fed into fiber inlet 38 are grabbed by anvil assembly 48 and idler wheel 50 and pushed between anvil assembly 48 and cutter blade head 46. Blades 54 of cutter blade head 46 are pushed into roller body 62, which comprises a deformable material. The rovings are sliced between blades 54 and roller body 62 as blades 54 rotate anvil assembly 48 and cut into roller 62. Spacer spool 58 maintains blades 54 at even intervals so that the fibers are consistently cut into similarly sized lengths. Blades 54 and roller body 62 become worn and eventually need to be replaced to prevent unacceptable performance degradation of fiber chopper 12. Roller 68 is slid off its mounting shaft and removed from housing 24 to perform maintenance. Blade cartridge 56 can be replaced after retention cap 60 is removed. Fasteners are removed from spacer spool 58 to allow cutter blade head 46 to slide off of its shaft. Similarly, anvil assembly 48 is slid off its mounting shaft so that roller body 62 can be replaced. Although, roller body 62 can be replaced by simply removing retention cap 64.

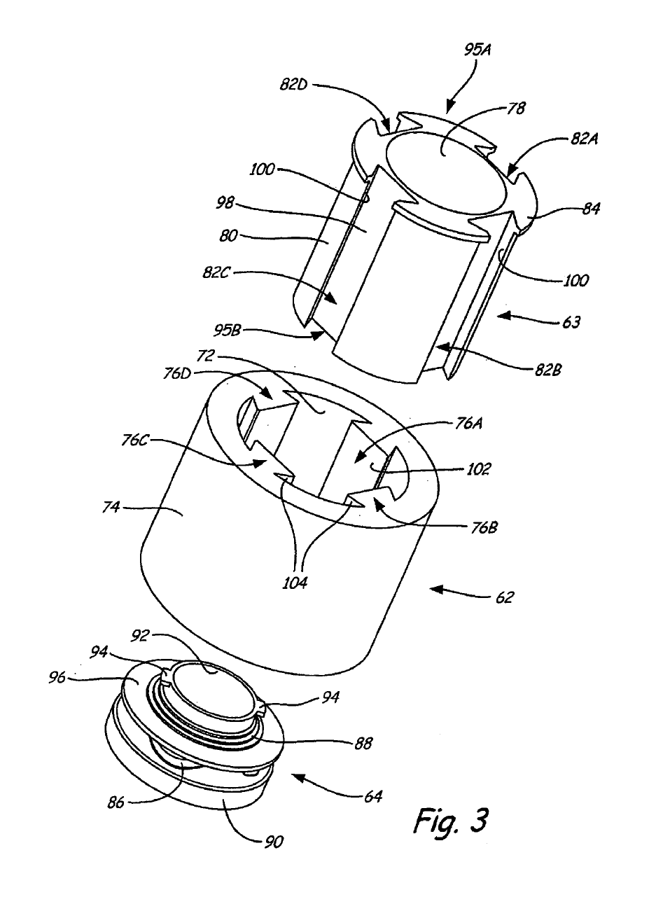

FIG. 3 is an exploded view of anvil assembly 48 of FIG. 2C showing roller body 62, anvil wheel 63 and retention cap 64. Roller body 62 includes inner diameter surface 72, outer diameter surface 74 and dovetails 76A-76D. Anvil wheel 63 includes inner diameter surface 78, outer diameter surface 80, dovetail slots 82A-82D and roller retention flange 84. Retention cap 64 includes biasing spring 86, retaining ring 88, end plate 90, central body 92, tabs 94 and retention plate 96.

Anvil wheel 63 comprises a rigid annular structure that provides support to roller body 62 and that can be mounted to housing 24 of chopper 12 (FIG. 2). For example, inner diameter surface 78 can be mounted to a shaft or on a bearing within chopper 12. Thus, inner diameter surface 78 forms a central bore extending along an axis between first end 95A and second end 95B. Anvil wheel 63 is typically formed of a metal material such as a carbon steel or hard plastic.

Outer diameter surface 80 provides a smooth cylindrical surface upon which roller body 62 can be mounted. Dovetail slots 82A-82D are formed into outer diameter surface 80. Dovetail slots 82A-82D are approximately equally spaced around the circumference of outer diameter surface 80. Dovetail slots 82A-82D comprise base surfaces 98 that extend approximately parallel to the axis of anvil wheel 63, and sidewalls 100 that extend generally radially outward from base surface 98. However, sidewalls 100 within a single dovetail slot are angled toward each other to overhang base surface 98 to form a dovetail configuration.

Outer diameter surface 80 of anvil wheel 63 is substantially the same diameter as or slightly smaller in diameter than inner diameter surface 72 of roller body 62. This permits anvil roller 62 to be easily slid over outer diameter surface 80. In other embodiments, outer diameter surface 80 is slightly larger than inner diameter surface 72 to provide a snug fit, but not so as to cause an interference fit. First end 95A includes roller retention flange 84 that prevents anvil roller 62 from sliding off of anvil wheel 63.

Roller body 62 comprises an annular shape in which inner diameter surface 72 and outer diameter surface 74 extend co-axially with the central axis of anvil wheel 63. Outer diameter surface 74 of roller body 62 forms an engagement surface for razor blades 54 of cutter blade head 46 (FIG. 2). Inner diameter surface 72 forms an engagement surface for anvil wheel 63. Roller body 62 is formed of a resilient and deformable material. In one embodiment, roller body 62 is comprised of natural rubber, although other materials can be used. The deformable properties of rubber and other materials permits razor blades 54 (FIG. 2) to penetrate outer diameter surface 80 of roller body 62 when slicing through fiber rovings, but that enable roller body 62 to return to form after engagement with blades 54. The deformable properties also allow roller body 62 to deform to fit around anvil wheel 63 in various embodiments. In the embodiment shown, outer diameter surface 74 and dovetails 76A-76D are parts of the same homogenous body of material to facilitate easy manufacture. In other embodiments only outer diameter surface 74 is formed of deformable material and dovetails 76A-76D are formed of a different harder material to form a more rigid engagement with dovetail slots 82A-82D.

Inner diameter surface 72 slides over outer diameter surface 80 of anvil wheel 63 and, if desired, is sized to deform to snuggly fit on anvil wheel 63. Inner diameter surface 72 includes dovetails 76A-76D that slide into dovetail slots 82A-82D of anvil wheel 63. Dovetails 76A-76D include inner surfaces 102 and sidewalls 104. Inner surfaces 102 extend approximately parallel to the central axis of anvil wheel 63 and, thus, parallel to base surfaces 98 of dovetail slots 82A-82D. Sidewalls 104 extend generally radially inwardly from base surfaces 98. However, sidewalls 104 within a single dovetail are angled away from each other to overhang inner diameter surface 72 to form a dovetail configuration.

The embodiment of FIG. 3 shows only one configuration of the dovetail retention slot feature of the present invention. In other embodiments, slots 82A-82D and dovetails 76A-76D can have other configurations with different retention features than the illustrated overhanging sidewalls. For example, dovetail slots 82A-82D can have non-planar surfaces that form a lobed or oval dovetail, with dovetails 76A-76D having correspondingly shaped features. In general, any embodiment having a neck with a smaller width than a base, such that the neck overhangs the base to engage a projection having an opposite profile will provide an adequate radial retention feature.

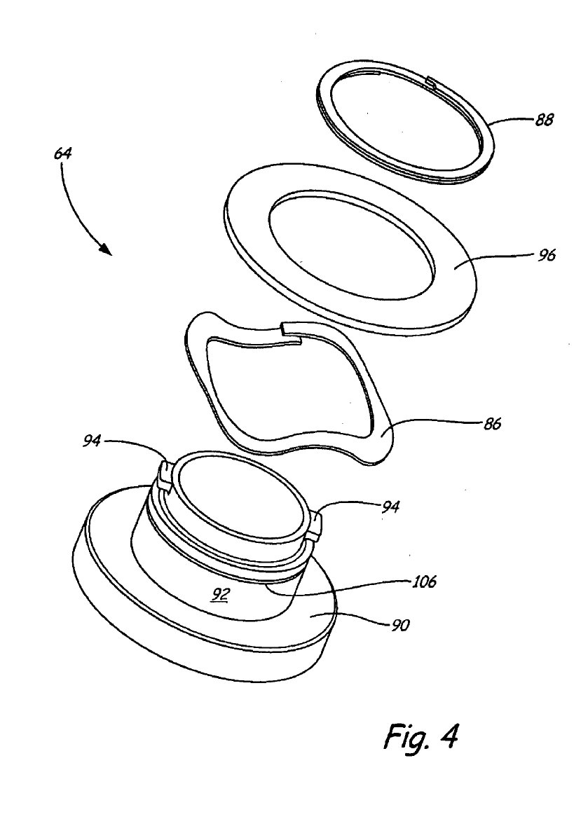

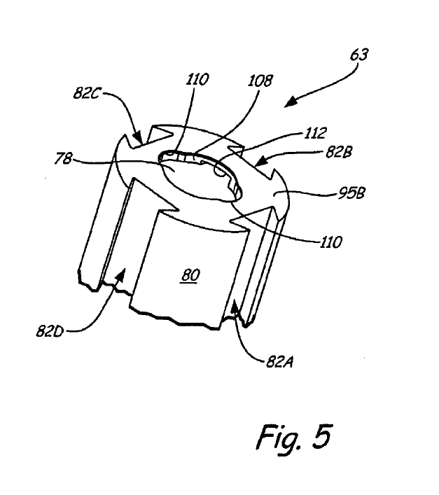

Retention cap 64 is configured to engage anvil wheel 63 within inner diameter surface 78. Specifically, retention spring 86 is pushed by end plate 90 to push retention plate 96 into roller body 62, as discussed with reference to FIG. 4. Also, tabs 94 engage mating features within anvil wheel 63, as discussed with reference to FIG. 5, to maintain assembly roller body 62 engaged with flange 84.

FIG. 4 is an exploded view of retention cap 64 of FIG. 3 showing biasing spring 86, retaining ring 88, end plate 90, central body 92, retention tabs 94, retention plate 96 and ring seat 106. Biasing spring 86 rests against end plate 90 when fitted around central body 92. Biasing spring 86 comprises a split wave spring ring that includes waves that engage retention plate 96. Retention plate 96 is fitted around central body 92 such that spring 86 is retained between end plate 90 and retention plate 96. Retaining ring 88 comprises a split washer that snaps into ring seat 106. With retaining ring 88 seated in ring seat 106, retention plate 96 is prevented from sliding off of central body 92. Biasing spring 86 maintains retention plate 96 in engagement with retaining ring 88, but can be displaced toward end plate 90 when acted upon with force, such as when tabs 94 are engaged with mating retention features in anvil wheel 63.

FIG. 5 is a perspective view of second end 95B of anvil wheel 63 of FIG. 3 showing cap retention flange 108 for engaging retention tabs 94 of FIG. 4. Anvil wheel 63 includes inner diameter surface 78, outer diameter surface 80, dovetail slots 82A-82D and flange 108. Cap retention flange 108 includes indents 110 and groove 112.

As discussed with reference to FIG. 3, inner diameter surface 78 forms a central bore that enables anvil wheel 63 to be mounted within chopper 12. Outer diameter surface 80 includes dovetail slots 82A-82D that mate with dovetails 76A-76D of roller body 62 (FIG. 3). Second end 95B of anvil wheel 63 extends between inner diameter surface 78 and outer diameter surface 80 and includes flange 108. Flange 108 extends radially inward past inner diameter surface 78 into the interior bore of anvil wheel 63. Flange 108 includes a circular opening in which indents 110 are positioned to produce an oval-like opening. Thus, indents 110 do not extend as radially inward as the remainder of flange 108. Indents 110 are spaced on opposite sides of flange 108. Flange 108 also includes grooves 112, only one of which is shown in FIG. 5; the other being located opposite the one shown. Grooves 112 are disposed within the interior of anvil wheel 63 and are shaped to receive tabs 94 of retention cap 64. Grooves 112 comprise axially thinner portions of flange 108 that have steep sidewalls to prevent tabs 94 from slipping out once positioned within grooves 112 when anvil assembly 48 is fully put together.

With reference to FIG. 3, retention cap 64, roller wheel 62 and anvil wheel 63 include central bores that align along a central axis such that anvil assembly 48 can be put together and mounted on a support shaft. Inner diameter surface 78 of anvil wheel 63 can be placed around a shaft within a fiber roving chopper. Roller body 62 is slid over outer diameter surface 80 of anvil wheel 63. Specifically, dovetails 76A-76D are circumferentially aligned with dovetail slots 82A-82C such that inner surfaces 102 are centered on base surfaces 98. Sidewalls 104 roller wheel 62 are slid along sidewalls 100 anvil wheel 63 so roller body 62 engages flange 84. With retention cap 64 assembled, central body 92 is inserted into inner diameter surface 78 of anvil wheel 63 with tabs 94 aligned with indents 110. In order to move tabs 94 past flange 108, retention cap 64 must be pushed into anvil wheel 63 to compress biasing spring 86. Specifically, end plate 90 is pushed such that retention plate 96 is pushed against roller body 62, thereby compressing spring 86. Once tabs 94 are past flange 108, retention cap 64 is rotated ninety degrees so that tabs 94 align with grooves 112 (only one shown in FIG. 3). Retention of tabs 94 in grooves 112 prevents rotation of central body 92 so that retention cap 64 does not become disengaged from anvil wheel 63 without axial displacement followed by rotational displacement. With tabs 94 in grooves 112, spring 86 is still in a state of compression such that retention plate 96 is biased against roller body 62, thereby maintaining roller body 62 in contact with flange 84. Fastener 66 is threaded onto the support shaft inserted into anvil wheel 63 to fasten anvil assembly 48 to fiber roving chopper 12.

The present invention provides a system for maintaining an anvil roller body on an anvil wheel that can be easily assembled and disassembled. For example, by simply pushing and twisting retention cap 64, full access to roller body 62 can be gained. Roller body 62 provides an easy to manufacture and disposable component that is easily slid off of anvil wheel 63 without having to stretch roller body 62. As such, anvil assembly 48 of the present invention increases efficiency in operating fiber roving chopper 12.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An anvil assembly for a fiber roving chopper, the anvil assembly comprising:
an annular roller comprising:
an inner diameter surface with a plurality of radial retention features; and
an outer diameter surface comprising a deformable material; and
an annular anvil wheel comprising:
an inner diameter surface forming a central bore for mounting the anvil assembly in the fiber roving chopper; and
an outer diameter surface extending between a first end and a second end and having a plurality of slots that receive the plurality of radial retention features.

2. The anvil assembly of claim 1 and further comprising:
a retention cap assembly holding the annular roller in assembly with the annular anvil wheel.

3. The anvil assembly of claim 2 wherein the annular anvil wheel further comprises:
a roller retention flange located on the outer diameter surface at the first end, wherein the retention cap assembly biases the annular roller against the retention flange.

4. The anvil assembly of claim 3 wherein the retention cap assembly further comprises:
an end plate;
a central body extending from the end plate and into the central bore of the annular anvil wheel;
a retention tab extending from the central body to engage the central bore;
a retention plate positioned between the end plate and the annular anvil wheel;
a spring positioned between the end plate and the retention plate; and
a retaining ring connected to the central body adjacent the retention plate.

5. The anvil assembly of claim 5 wherein the inner diameter surface of the anvil wheel further comprises a cap retention flange comprising:
a radially inwardly extending wall portion:
an indent to permit the retention tab to pass through the wall portion; and
a groove displaced circumferentially from the indent in which the retention tab sits.

6. The anvil assembly of claim 1 wherein the outer diameter surface of an annular anvil roller is comprised of rubber.

7. The anvil assembly of claim 1 wherein the annular anvil roller is comprised of rubber.

8. The anvil assembly of claim 1 wherein the annular anvil wheel is formed of metal.

9. A roving chopper comprising:
a chopper housing;
an anvil assembly mounted for rotation to the chopper housing, the anvil assembly comprising:
a deformable roller body; and
an anvil wheel upon which the deformable roller body is mounted;
wherein the deformable roller body is mounted to the anvil wheel through a dovetail slot connection; and
a cutter blade head mounted for rotation to the chopper housing, the cutter blade head comprising:
a plurality of razor blades extending from the cutter blade head to engage the deformable roller body of the anvil assembly when rotated.

10. The roving chopper of claim 9 and further comprising:
a retention cap assembly holding the deformable roller body in assembly with the anvil wheel.

11. The roving chopper of claim 10 wherein the anvil wheel further comprises:
a retention flange located on an outer diameter surface, wherein the retention cap assembly biases the deformable roller body against the retention flange.

12. The roving chopper of claim 11 wherein the retention cap assembly further comprises:
an end plate;
a central body extending from the end plate and into a central bore of the anvil wheel;
a retention tab extending from the central body to engage the anvil wheel;
a retention plate positioned between the end plate and the anvil wheel;
a spring positioned between the end plate and the retention plate; and
a retaining ring connected to the central body adjacent the retention plate.

13. The roving chopper of claim 12 wherein the inner diameter surface of the anvil wheel further comprises a cap retention flange comprising:
a radially inwardly extending wall portion:
an indent to permit the retention tab to pass through the wall portion; and
a groove displaced circumferentially from the indent in which the retention tab sits.

14. The roving chopper assembly of claim 9 wherein:
the anvil roller is comprised of rubber; and
the anvil wheel is formed of metal.

15. The roving chopper of claim 9 and further comprising:
an air motor mounted to the chopper housing to provide rotational input to the anvil assembly or cutter blade head; and
an idler wheel mounted for rotation on the chopper housing to engage the deformable roller body.

16. The fiber roving chopper of claim 15 and further comprising:
an inlet mounted to the chopper housing to feed rovings between the deformable roller body and the idler wheel;
a cover mounted to the chopper housing; and
a dispenser mounted to the housing to receive chopped rovings from between the deformable roller body and the cutter blade head and discharge the chopped rovings from the chopper housing.

17. An anvil assembly for use in a fiber roving chopper, the anvil assembly comprising:
an anvil wheel comprising:
an annular body having an inner diameter and an outer diameter extending along a central axis; and
a plurality of slots located in the outer diameter surface, the slots including:
an axially extending base; and
a circumferentially extending retention feature that overhangs the base; and
a roller body comprising:
an annular body having an inner diameter and an outer diameter extending along the central axis; and
a plurality of radially inwardly extending projections each having a circumferentially extending portion that engages one of the plurality of retention features to prevent radial displacement of the roller body.

18. The anvil assembly of claim 17 and further comprising:
a radially outwardly extending flange located on the outer diameter of the annular body of the anvil wheel; and
a retention cap assembly fastened to the annular body of the anvil wheel to bias the annular body of the roller body toward the radially outwardly extending flange.

19. The anvil assembly of claim 18 wherein:
the retention cap assembly includes tabs that extend into the annular body of the anvil wheel; and
the annular body of the anvil wheel further comprises a radially inwardly extending flange having:
indents having profiles to allow the tabs to pass through; and
grooves in which the tabs sit after passing through the indents.

20. The anvil assembly of claim 17 wherein:
the retention feature comprises a first sidewall angled radially outwardly from the base to circumferentially overhang the base; and
the circumferentially extending portion comprises a second sidewall angled to mate with the first sidewall.
